(19) United States
(12) Patent Application Publication
(10) Pub. No.: US 2010/0028577 A1
(43) Pub. Date: Feb. 4, 2010

(54) PREFORM FOR THE PRODUCTION OF BIAXIALLY EXTENDED PLASTIC BOTTLES AND PLASTIC BOTTLE PRODUCED FROM A PREFORM

(75) Inventor: Robert Siegl, Dornbirn (AT)

Correspondence Address: MORRISS OBRYANT COMPAGNI, P.C., 734 EAST 200 SOUTH, SALT LAKE CITY, UT, 84102, US

(73) Assignee: ALPLA WERKE ALWIN LEHNER GMBY & CO. KG, Hard (AT)

(21) Appl. No.: 12/447,182

(22) PCT Filed: Oct. 5, 2007
(86) PCT No.: PCT/EP07/08674

§ 371 Date: Aug. 27, 2009

(30) Foreign Application Priority Data
Oct. 24, 2006 (CH) 01687/06

(51) Int. Cl. B32B 1/02; B29C 45/16; B29C 49/22; B29C 49/06; B29B 11/14; B29B 11/08

(52) U.S. Cl. 428/35.7; 264/328.1

(57) ABSTRACT

A preform (1) for the production of biaxially extended plastic bottles has a rigid, substantially elongated body (2), which at one longitudinal end thereof comprises a base (3) and the opposite longitudinal end of which is configured as a neck section (4) provided with a pouring opening (5). The preform (1) has outer and inner walls (A, I), which extend at least across a partial region of the axial length thereof and are formed by separate plastic layers. At least one intermediate layer (Z) is embedded in at least a partial region of the body (2) in a space delimited by the outer and inner walls (A, I) of the body (2), the intermediate layer extending across part of the axial length and the circumference of the body (2) and having a color that deviates from the outer or inner layers (A, I).

### CROSS-REFERENCE TO RELATED APPLICATIONS

This application claims priority to PCT/EP2007/008674 filed on Oct. 5, 2007, and CH1687/06 filed on Oct. 24, 2006, the entirety of which are incorporated by this reference.

### BACKGROUND OF THE INVENTION

1. Field of the Invention

The invention pertains to a preform for the manufacture of biaxially stretched plastic bottles with a rigid, essentially elongated body that has a bottom at one longitudinal end and the opposite longitudinal end being designed as a neck section with an opening for pouring. The preform has an outside wall and an inside wall, the walls extending at least along part of the axial length of the preform and being formed from separate plastic layers. The invention also pertains to a plastic bottle made from the preform.

2. State of the Art

Containers used in the past, which were usually made of tin or non-ferrous metal sheeting, glass or ceramics, are being increasingly phased out by plastic containers. For the packaging of liquid substances in particular, such as drinks, household products, personal care products, cosmetics, etc., plastic containers are used most of the time. The low weight and lower costs have certainly played a significant role in this substitution. The use of recyclable plastic materials and the better total energy balance overall involved in their manufacture have also helped to promote the acceptance of plastic containers, in particular plastic bottles, by consumers.

The most frequently used plastic bottles are made of polyethylene terephthalate, or PET, or its slightly modified copolyesters; these bottles are usually produced in a so-called injection stretch blow molding process. This process involves a combination of injection molding and blow molding. First, a preform is produced in an injection mold in an injection molding process. Recently, cold extrusion methods have also been proposed for the manufacture of preforms. The preform has an essentially elongated cylindrical body with a bottom at one longitudinal end. A support ring separates the body from a neck section that has an opening for pouring. This neck section usually already has the shape of the later neck of the bottle. On the outside of this neck section, threaded sections or the like are usually already made for the attaching of a closure part. After it is prepared in a plastic injection molding process, the pre-form is de-molded from the injection mold, conditioned if necessary and placed into a blow mold of a blowing machine in which it is finally blown to the desired shape through pressurization and also stretched using a stretching mandrel. The plastic bottle so biaxially stretched is then de-molded.

There is also a known injection blowing process in which the blowing takes placed directly following the injection molding of the preform. In the process, the preform remains on the injection mandrel and part of the injection mold constitutes a section of the blow mold.

Already known from the prior art are plastic bottles produced in extrusion blow molding processes, said bottles having areas of different color and/or having longitudinal decorative stripes. The areas of defined color or strips generally do not perform a technical function and are only for purposes of changing the external appearance of the plastic container. In these known plastic containers, the areas of defined color or stripes exhibit a relatively long transition zone in which the base color switches to the different colored area or from this area and back to the base color. Sometimes this effect is actually intended; however, in general it is not very visually appealing and does not achieve the desired effect. Therefore, these plastic bottles produced in the extrusion blow molding process, with the transitions extending along a relatively long distance, are very seldom used.

On the other hand, biaxially stretched plastic bottles produced in a stretch blow molding process are always produced in one color. To this end, a lot of effort is placed on providing the preforms with an even, full pigmentation. Color effects are always accomplished by coating the plastic bottle later on or by attaching films and the like to it. On the other hand, when it comes to biaxially stretched plastic bottles made in a stretch blow molding process, in particular PET bottles which make up the bulk of plastic bottles, there is a need for targeted pigmentation that can exhibit both aesthetic and functional properties. For example, a targeted pigmentation could indicate to the consumer where best to grasp a hold of the bottle. Targeted pigmentation of the plastic bottle can also be useful for subsequent processing steps, such as for the identification of labeling areas or to facilitate pattern recognition for a robotically-controlled transport and/or handling system.

The object of the present invention is therefore to create a preform for the manufacture of biaxially stretched plastic bottles, this preform making it possible to produce plastic bottles with specifically located color effects. In the process, the preform should be producible in a conventional manner and further processed in the usual fashion in a stretch blow molding process. Additional technical effort and additional costs for the preform manufacture are to be largely avoided. A further object of the present invention is to provide a biaxially stretched plastic bottle that exhibits color effects to the desired extent.

### SUMMARY OF THE INVENTION

The solution of these objects is found in a preform for the manufacture of biaxially stretched plastic bottles that has the features listed in the characterizing section of patent claim 1. Further developments and/or advantageous embodiments of the invention are objects of the dependent claims. Biaxially stretched plastic bottles produced from the preform according to the invention are objects of claims directed to the same.

The preform according to the invention for the production of biaxially stretched plastic bottles has a rigid, essentially elongated body that has a bottom at one of its longitudinal ends and whose opposite longitudinal end is designed as a neck section provided with an opening for pouring. The preform has an outside wall and an inside wall that extend at least part of the way along the axial length of the preform, said walls formed from separate plastic layers. An intermediate layer is embedded in at least part of the body in a spaced bounded by the outside and inside wall of the body, the intermediate layer extending along part of the axial length and circumference of the body and having a coloring that is different from the outside and inside layers.

Whereas for the conventional multi-layered plastic bottles known from the prior art, performs are used that have one or more intermediate layers extending as evenly as possible along the entire body of the preform, according to the invention a preform is created that has at least one intermediate layer that extends along only part of the body of the preform. The intermediate layer has a coloring that differs from the inside and outside layers. This makes it possible to achieve in the finished stretch-blown plastic bottle special visual effects, color transitions, mixed colors, 3-D effects and effects that depend on the viewing angle of the viewer.

A useful variation of the invention provides that at least the outside layer of the body is designed to be transparent. By means of the color of the base material of the inside layer and the transparent outside layer, and by means of the different coloring of the intermediate layer(s) additive or subtractive color mixtures and transitions are possible.

Another embodiment of the invention provides that all layers of the body are designed to be transparent. This enables color interactions between the layers and colored contents. By means of different density gradients in the contents itself, this can provide even more visual effects.

The intermediate layer does not necessarily have to extend along the entire circumference of the body of the preform. To simplify the injection molding manufacture of the preform, it is advantageous to design at least one intermediate layer to be annular and along the entire circumference of the body.

In another variation of the preform according to the invention, the intermediate layer has a variable thickness along its axial and/or radial extent. Whereas in known preforms and biaxially stretched plastic bottles produced therefrom, as even a wall thickness as possible of the intermediate layer is critical, for example to act as a barrier layer, the invention makes the thickness deviations a useful way to controllably achieve specific visual effects, such as 3D effects.

In another variation of the invention, it is possible for the intermediate layer to penetrate the outer layer near the bottom and/or near the neck of the body for purposes of identification, in particular to be used in fully-automatic processing systems with pattern recognition.

To raise certain areas of the stretch-blown plastic bottle, the preform according to the invention can have two or more intermediate layers along the axial length of its body, said layers extending annularly along the circumference of the body. This provision can identify the area where the label is to be attached, for example. Also, this can indicate to the consumer where the bottle should be most effectively grasped.

By making the at least one intermediate layer from a material that does not bond, or only poorly bonds, to the outside and/or inside layer, the pigmented layer be easily separated from the remaining layers and separately re-processed when the plastic bottle is recycled. This also permits the use of pigmented materials that have a lower food grade level without affecting the recyclability of the plastic bottles in the process.

A proven method of cost-effectively producing the preform according to the invention has been shown to be a multi-layer plastic injection molding process. These processes have been known for some time for the manufacture of multi-layered preforms and have been tested and are suitable for cost-effective mass production. In contrast to known methods, the injection molding process for the manufacture of the preforms according to the invention is controlled in such manner that one or more intermediate layers are produced in only parts of the body. This is accomplished without the need for extensive design modifications by appropriately controlling the injection molding times and amounts of materials for the intermediate layer(s) and by controlling the injection molding rates.

Biaxially stretched plastic bottles that are produced from any of the variations of preforms according to the invention are characterized by special visual effects. They can exhibit color transitions, mixed colors, 3-D effects or effects that depend on the viewing angle. The color effects can be employed in interaction with the contents of the plastic bottles, such as to more simply and easily determine the fill level of the bottle.

### BRIEF DESCRIPTION OF THE DRAWINGS

Other advantages and features are given in the following description of exemplary embodiments of the invention, with reference to the schematic figures. Shown are (not to scale):

FIG. 1-FIG. 6 different embodiment variations of the preform according to the invention.

### DETAILED DESCRIPTION OF THE INVENTION

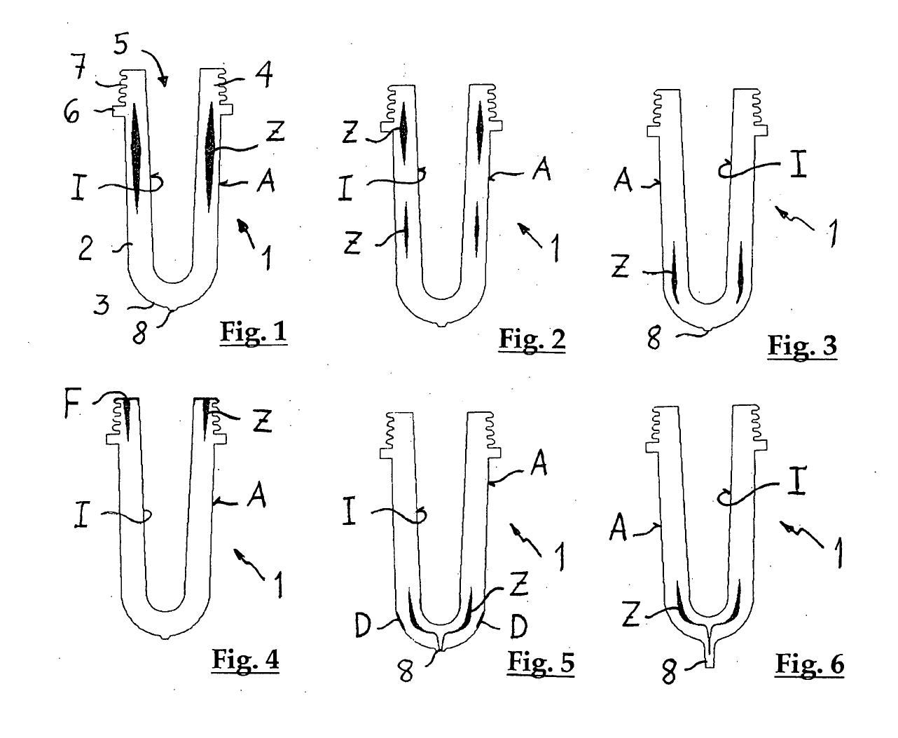

The embodiment variations shown in FIG. 1-FIG. 6 as examples of preforms are each identified in their entirety with reference label 1. They have an elongated body 2, one end of which is closed off by a bottom 3, which is normally cambered. At the opposite end, the body 2 has a neck section 4 that has an opening for pouring 5. The neck section 4 is separated from the remainder of the body 2 of the preform by means of a flange-like overhanging support ring 6. The neck section 4 is commonly provided with threaded sections 7 or the like on its exterior. The body 2 of the preform 1 has an outside wall A and an inside wall I. According to the invention, the preform 1 has at least one intermediate layer Z between the two layers A, I; this intermediate layer is provided in only part of the length of the preform. The intermediate layer Z can only extent along part of the circumference of the body 2 of the preform 1 or it can be annular. The intermediate layer Z does not have to be located precisely in the middle between the inside wall I and the outside wall A, but can also run more along the outside wall A or the inside wall I. The preforms 1 are produced in a multi-layer plastic injection molding process. Suitable materials for the outside and inside layers A and I include PET, polypropylene, polystyrene, HDPE, LDPE and the like. The injection point of a preform 1 at the bottom 3 of the body 2 is provided with the reference label 8.

FIG. 1 shows a preform 1 whose intermediate layer Z has a wall thickness that varies in the axial direction due to special injection molding rate settings. In this manner, for example, a color gradient is possible from top to bottom. The position of the intermediate layer Z when this begins or ends can be controlled by the starting and stopping of the injection of the pigmented components that are injected between the two outer layers A, I using a second injection system during the manufacture of the preform.

FIG. 2 shows a preform that has two intermediate layers Z that are arranged axial atop one another. This is done by controlling the starting and stopping of the injection of the pigmented material using the second injection system. In a similar manner, more than two intermediate layers can also be generated.

FIG. 3 shows a preform 1 whose intermediate layer Z is located near the injection point 8.

FIG. 4 shows a preform 1 whose intermediate layer Z sits against the outside by means of a very early addition of the pigmented material in the neck section 4 of the preform 1. In particular, the intermediate layer Z penetrates the outside wall A at the free end of the neck section 4 and forms color wrinkles F.

In the exemplary preform 1 shown in FIG. 5, the intermediate layer Z extends into the injection point 8. This is accomplished in that the injection nozzle already contains pigmented material that accumulates against the inner layer or against the outer layer when the preform 1 is injected. The material accumulated against the outside wall A of the preform is indicated by reference label D. This facilitates special color gradients on the finished stretch-blown plastic bottle.

Shown in FIG. 6 is a preform 1 in which residue of the pigmented material is prevented from uncontrollably contaminating the nozzle area of the injection cavity through the use of as long an injection point 8 as possible. This prevents accumulations of pigmented material at the outside wall A of the preform 1 as are provided intentionally in the exemplary embodiment according to FIG. 5. The long injection point 8 is finally cut off in a separate work step.

The variations of preforms shown in FIG. 1-6 are only provided as examples. It is understood that the different variations of embodiments (with the exception of the combination of variations according to FIG. 5 and FIG. 6) can be combined with one another arbitrarily to produce other preforms derived therefrom. The preforms designed according to the invention are further processed in the usual manner in a stretch blow molding process to produce biaxially stretched plastic bottles therefrom.

1. A preform for the manufacture of biaxially stretched plastic bottles, comprising:
a rigid, essentially elongated body that has a bottom at one longitudinal end, the opposite longitudinal end being designed as a neck section with an opening for pouring;
an outside wall and an inside wall, said walls extending at least along part of the axial length of the preform and being formed from separate plastic layers;
at least one intermediate layer embedded in part of the body in a space bounded by the outside wall and the inside wall of the body, said intermediate layer extending along part of the axial length and circumference of the body and having a coloring that deviates from the outside and inside layers.

2. The preform according to claim 1, wherein at least the outer layer of the body is transparent.

3. The preform according to claim 1, wherein all layers of the body are transparent.

4. The preform according to claim 1, wherein the intermediate layer is annular and extends along the entire circumference of the body.

5. The preform according to any of the previous claims, characterized in that the intermediate layer has a variable thickness along its axial and/or radial length.

6. The preform according to claim 1, wherein the intermediate layer near the bottom and/or near the neck section of the body penetrates the outside wall.

7. The preform according to claim 1, wherein two or more intermediate layers are provided along the axial length of the body that extend annularly along the circumference of the body.

8. The preform according to claim 1, wherein the at least one intermediate layer is made of a material that does not bond, or poorly bonds, to the outside and/or inside layer.

9. The preform according to claim 1, wherein the preform is produced in a multi-layer plastic injection molding process.

10. The perform according to claim 1, wherein the perform forms a biaxially stretched plastic bottle produced in a stretch blow molding process.
